(19) United States
(12) Patent Application Publication
(10) Pub. No.: US 2024/0267982 A1
(43) Pub. Date: Aug. 8, 2024

(54) VALIDITY TIME FOR A CONFIGURATION

(71) Applicant: QUALCOMM Incorporated, San Diego, CA (US)

(72) Inventors: Naeem AKL, Bridgewater, NJ (US); Karl Georg HAMPEL, Jersey City, NJ (US); Navid ABEDINI, Basking Ridge, NJ (US)

(21) Appl. No.: 18/421,077

(22) Filed: Jan. 24, 2024

Related U.S. Application Data
(60) Provisional application No. 63/483,689, filed on Feb. 7, 2023.

(51) Int. Cl. H04W 76/27; H04B 7/155; H04W 76/38; H04W 88/04

(52) U.S. Cl. CPC H04W 76/27; H04W 76/38; H04B 7/15557; H04W 88/04

(57) ABSTRACT

Various aspects of the present disclosure generally relate to wireless communication. In some aspects, a repeater may receive a side control configuration from a radio access network (RAN) node. The repeater may receive an indication of a validity time associated with the side control configuration. The repeater may forward signaling to or from the RAN node based on the side control configuration for a duration of the validity time. Numerous other aspects are described.

### CROSS-REFERENCE TO RELATED APPLICATION

This Patent Application claims priority to U.S. Provisional Patent Application No. 63/483,689, filed on Feb. 7, 2023, entitled “VALIDITY TIME FOR A SIDE CONTROL CONFIGURATION,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for using a validity time for a side control configuration.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some networks, a UE may be radio resource control (RRC) released to an RRC state associated with a core network (CN) node. In the RRC state associated with the CN node, a radio access network (RAN) node be unable to page the UE to reestablish an RRC connection. Based at least in part on the RAN node being unable to page the UE to reestablish the RRC connection, the RAN node may be unable to transmit control information or data to the UE while the UE is in the RRC state associated with the CN node (e.g., an RRC-idle state). In this case, the RAN node may be unable to provide control information that may have otherwise been used to conserve power, network, communication, or computing resources and/or an additional UE having a link to the RAN node via the UE may experience radio link failure and/or poor spectral efficiency. Additionally, or alternatively, the data may become stale and unusable, which may degrade performance and/or a user experience at the UE or the additional UE.

In some aspects described herein, a repeater (e.g., a network controlled repeater (NCR) mobile terminal (MT)) may receive a side control configuration from a RAN node. Within the side control configuration or another communication, the repeater may receive a validity time associated with the side control configuration. The validity time may be associated with an amount of time for which the side control configuration is to be used without receiving a new side control configuration or an update to the side control configuration. In some aspects, the validity time may be measured from reception of the side control configuration, reception of an indication of the validity time, or reception of an indication of an RRC release. Upon expiry of the validity time, the repeater may stop using the side control configuration for a forwarding operation. For example, the repeater may stop forwarding, begin a forwarding operation using a default or otherwise configured side control configuration, and/or initiate an RRC reconnection process, among other examples.

In this way, the RAN node may provide a side control configuration to the repeater when the repeater is otherwise unreachable by the RAN node using a RAN-node-initiated indication of the side control configuration. The side control configuration may be used to conserve power, network, communication, or computing resources and/or a UE having a link to the RAN node via the repeater may avoid radio link failure and/or communicate with improved spectral efficiency. Additionally, or alternatively, the data may be provided to the repeater within a latency requirement and/or before expiry of the date, which may improve performance and/or a user experience at the UE.

Some aspects described herein relate to a method of wireless communication performed by a repeater. The method may include receiving a side control configuration from a RAN node. The method may include receiving an indication of a validity time associated with the side control configuration. The method may include forwarding signaling to or from the RAN node based on the side control configuration for a duration of the validity time.

Some aspects described herein relate to a method of wireless communication performed by a repeater. The method may include receiving a side control configuration from a RAN node. The method may include releasing an RRC connection with the RAN node. The method may include receiving a short message in a paging control channel, the short message providing information associated with the side control configuration.

Some aspects described herein relate to a repeater for wireless communication. The repeater may include a memory and one or more processors coupled to the memory. The one or more processors may be configured to receive a side control configuration from a RAN node. The one or more processors may be configured to receive an indication of a validity time associated with the side control configuration. The one or more processors may be configured to forward signaling to or from the RAN node based on the side control configuration for a duration of the validity time.

Some aspects described herein relate to a repeater for wireless communication. The repeater may include a memory and one or more processors coupled to the memory. The one or more processors may be configured to receive a side control configuration from a RAN node. The one or more processors may be configured to release an RRC connection with the RAN node. The one or more processors may be configured to receive a short message in a paging control channel, the short message providing information associated with the side control configuration.

Some aspects described herein relate to a non-transitory computer-readable medium that stores a set of instructions for wireless communication by a repeater. The set of instructions, when executed by one or more processors of the repeater, may cause the repeater to receive a side control configuration from a RAN node. The set of instructions, when executed by one or more processors of the repeater, may cause the repeater to receive an indication of a validity time associated with the side control configuration. The set of instructions, when executed by one or more processors of the repeater, may cause the repeater to forward signaling to or from the RAN node based on the side control configuration for a duration of the validity time.

Some aspects described herein relate to a non-transitory computer-readable medium that stores a set of instructions for wireless communication by a repeater. The set of instructions, when executed by one or more processors of the repeater, may cause the repeater to receive a side control configuration from a RAN node. The set of instructions, when executed by one or more processors of the repeater, may cause the repeater to release an RRC connection with the RAN node. The set of instructions, when executed by one or more processors of the repeater, may cause the repeater to receive a short message in a paging control channel, the short message providing information associated with the side control configuration.

Some aspects described herein relate to an apparatus for wireless communication. The apparatus may include means for receiving a side control configuration from a RAN node. The apparatus may include means for receiving an indication of a validity time associated with the side control configuration. The apparatus may include means for forwarding signaling to or from the RAN node based on the side control configuration for a duration of the validity time.

Some aspects described herein relate to an apparatus for wireless communication. The apparatus may include means for receiving a side control configuration from a RAN node. The apparatus may include means for releasing an RRC connection with the RAN node. The apparatus may include means for receiving a short message in a paging control channel, the short message providing information associated with the side control configuration.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of communicating using a millimeter wave repeater, in accordance with the present disclosure.

FIG. 5 is a diagram illustrating an example of communicating using a forwarding node (e.g., a relay and/or a repeater, such as a millimeter wave repeater), in accordance with the present disclosure.

FIG. 6 is a diagram illustrating an example of a radio resource control (RRC) release and paging process, in accordance with the present disclosure.

FIG. 7 is a diagram of an example associated with a validity time for a side control configuration, in accordance with the present disclosure.

FIG. 8 is a diagram of an example associated with a short message for a side control configuration, in accordance with the present disclosure.

FIG. 9 is a diagram illustrating an example process performed, for example, by a repeater, in accordance with the present disclosure.

FIG. 10 is a diagram illustrating an example process performed, for example, by a repeater, in accordance with the present disclosure.

FIG. 11 is a diagram of an example apparatus for wireless communication, in accordance with the present disclosure.

### DETAILED DESCRIPTION

Various aspects of the disclosure are described more fully hereinafter with reference to the accompanying drawings. This disclosure may however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

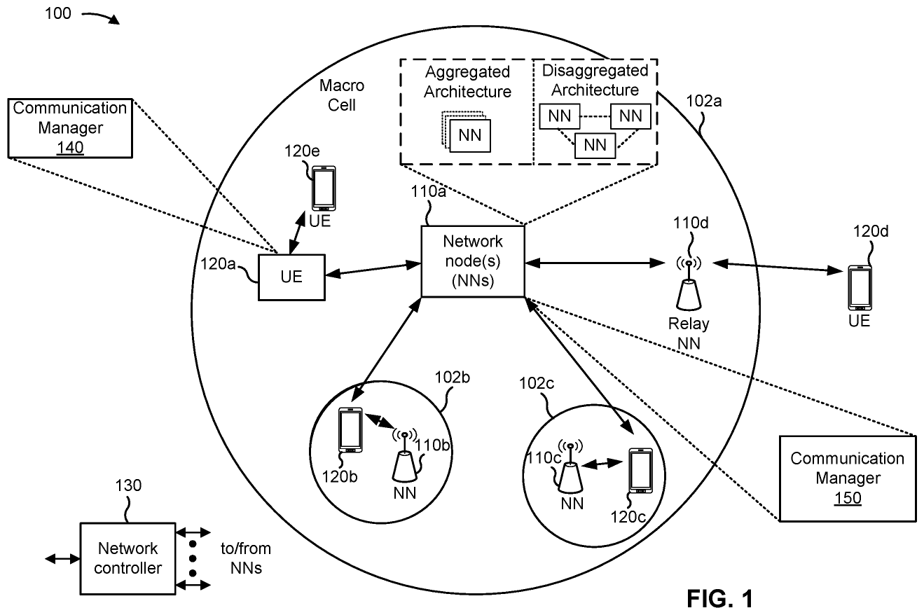

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the repeater (e.g., including a UE entity, such as an NCR-MT, and/or a network node entity, such as a forwarding component) may include a communication manager 140 and/or 150. As described in more detail elsewhere herein, the communication manager 140 and/or 150 may receive a side control configuration from a RAN node; receive an indication of a validity time associated with the side control configuration; and forward signaling to or from the RAN node based on the side control configuration for a duration of the validity time. Additionally, or alternatively, the communication manager 140 and/or 150 may perform one or more other operations described herein.

In some aspects, the repeater may include a communication manager 140 and/or 150. As described in more detail elsewhere herein, the communication manager 140 and/or 150 may receive a side control configuration from a RAN node; release a radio resource control (RRC) connection with the RAN node; and receive a short message in a paging control channel, the short message providing information associated with the side control configuration. Additionally, or alternatively, the communication manager 140 and/or 150 may perform one or more other operations described herein.

As indicated above, FIG. 1 is provided as an example. Other examples may differ from what is described with regard to FIG. 1.

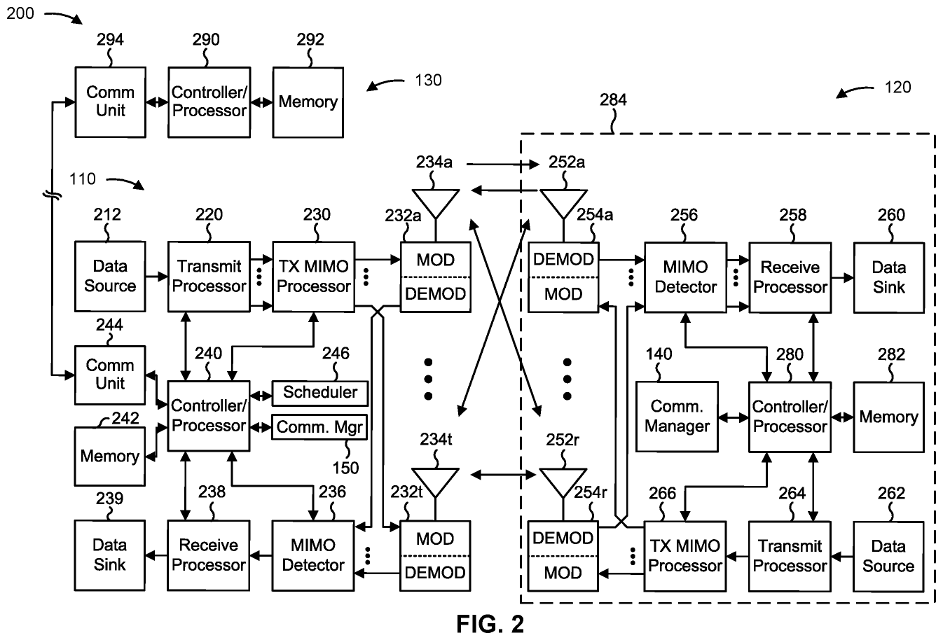

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

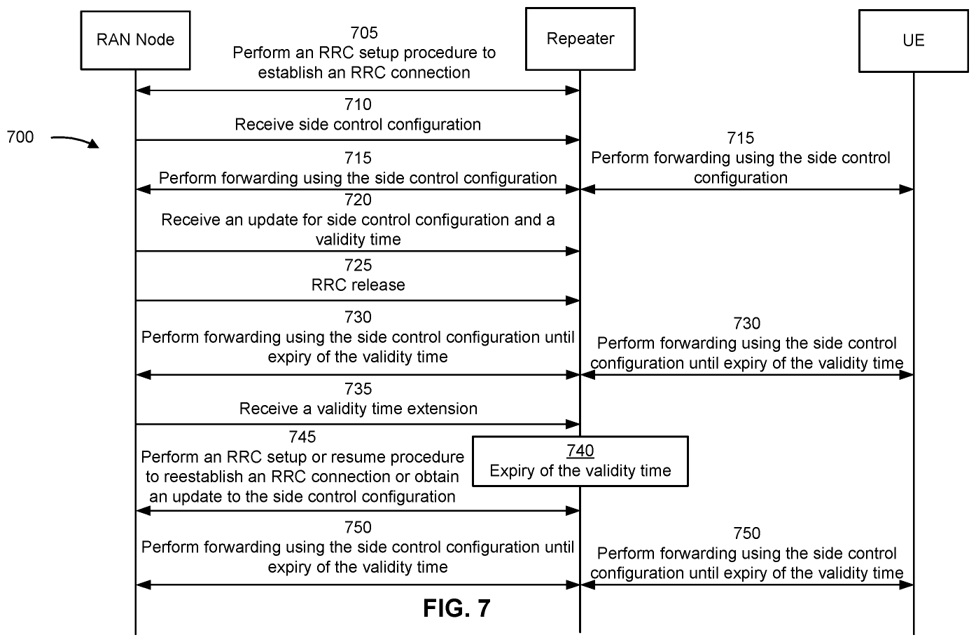

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7-12).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7-12).

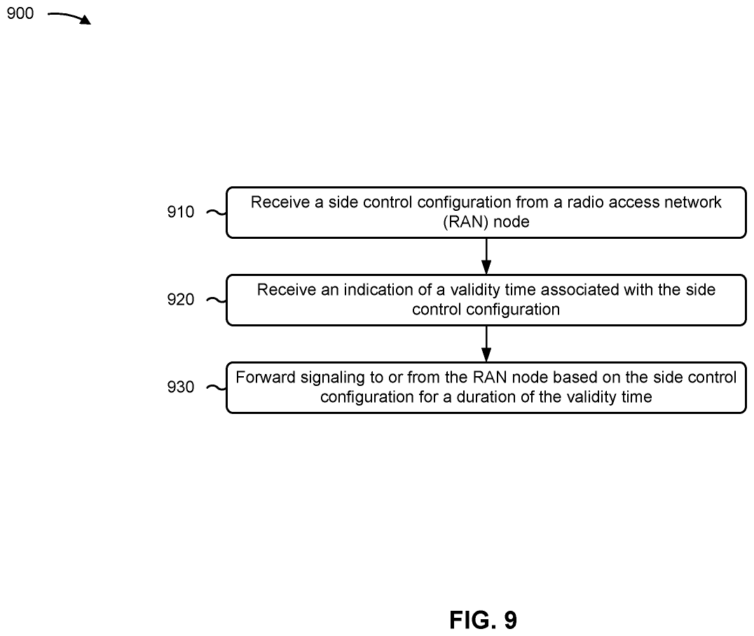

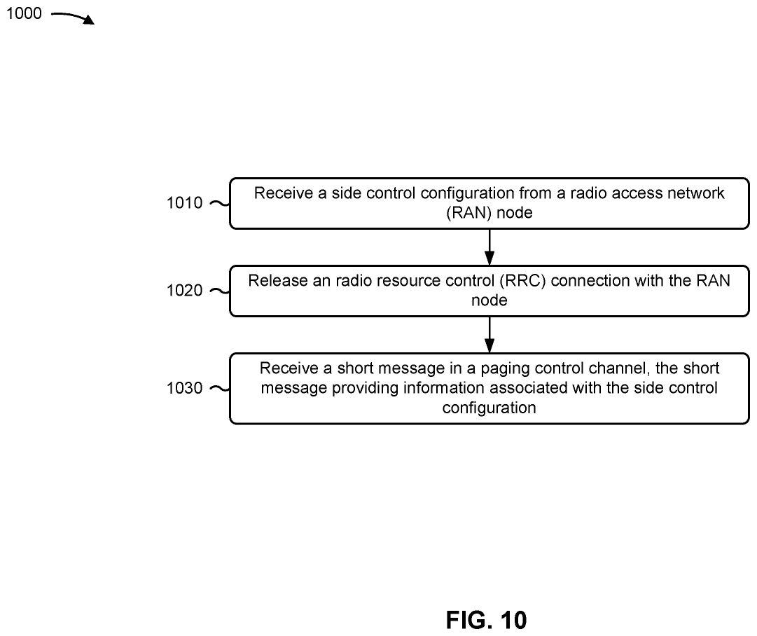

The controller/processor 240 of the network node 110, the controller/processor 280 of the UE 120, and/or any other component(s) of FIG. 2 may perform one or more techniques associated with using a validity time for a side control configuration, as described in more detail elsewhere herein. For example, the controller/processor 240 of the network node 110, the controller/processor 280 of the UE 120, and/or any other component(s) of FIG. 2 may perform or direct operations of, for example, process 900 of FIG. 9, process 1000 of FIG. 10, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 900 of FIG. 9, process 1000 of FIG. 10, and/or other processes as described herein. In some examples, executing instructions may include running the instructions, converting the instructions, compiling the instructions, and/or interpreting the instructions, among other examples.

In some aspects, the repeater includes means for receiving a side control configuration from a RAN node; means for receiving an indication of a validity time associated with the side control configuration; and/or means for forwarding signaling to or from the RAN node based on the side control configuration for a duration of the validity time. In some aspects, the repeater includes means for receiving a side control configuration from a RAN node; means for releasing an RRC connection with the RAN node; and/or means for receiving a short message in a paging control channel, the short message providing information associated with the side control configuration. In some aspects, the means for the repeater to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246. In some aspects, the means for the repeater to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

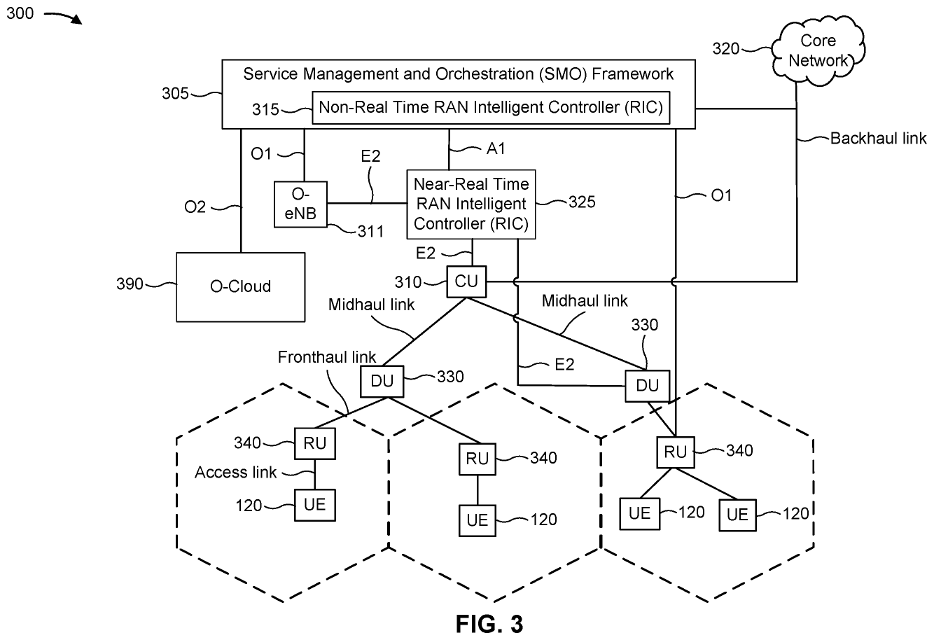

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include RRC functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

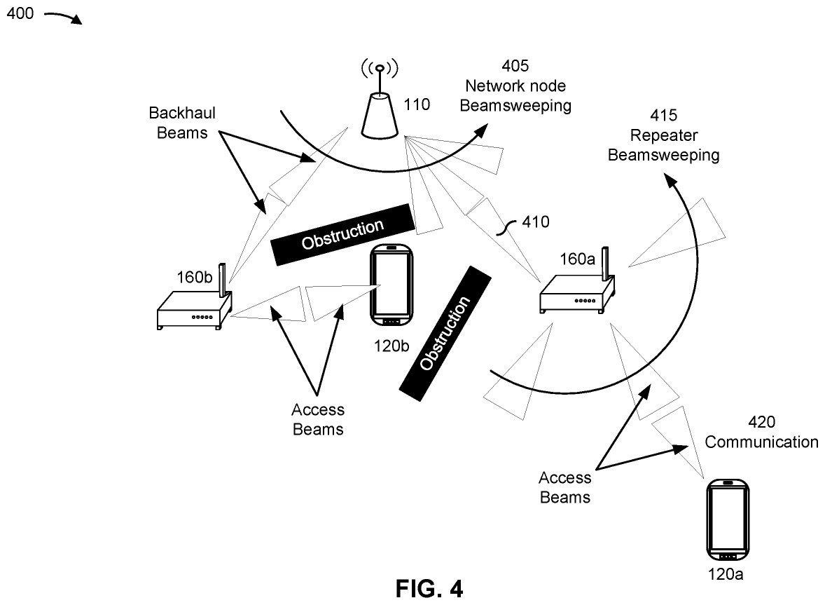

FIG. 4 is a diagram illustrating an example 400 of communicating using a millimeter wave repeater, in accordance with the present disclosure.

Because millimeter wave communications have a higher frequency and shorter wavelength than other types of radio waves used for communications (e.g., sub-6 GHz communications), millimeter wave communications may have shorter propagation distances and may be more easily blocked by obstructions than other types of radio waves. For example, a wireless communication that uses sub-6 GHz radio waves may be capable of penetrating a wall of a building or a structure to provide coverage to an area on an opposite side of the wall from a network node 110. However, a millimeter wave may not be capable of penetrating the same wall (e.g., depending on a thickness of the wall and/or a material from which the wall is constructed). Some techniques and apparatuses described herein use a millimeter wave repeater 160 (which includes, in the example of FIG. 4, repeater 160a and repeater 160b) to increase the coverage area of a network node 110 and/or to extend coverage to UEs 120 (which include, in the example of FIG. 4, UE 120a and UE 120b) without line of sight to the network node 110 (e.g., due to an obstruction).

For example, as illustrated in the example of FIG. 4, an obstruction between UE 120b and network node 110 blocks or otherwise reduces the quality of a link between the network node 110 and UE 120b. Similarly, an obstruction between UE 120b and repeater 160a blocks or otherwise reduces the quality of a link between the repeater 160a and the UE 120b. However, no obstructions or fewer obstructions exist between repeater 160b and UE 120b, and, as such, it is possible that communications between repeater 160b and UE 120b will have a higher quality than communications between network node 110 and UE 120b or between repeater 160a and UE 120b. Furthermore, the millimeter wave repeater 160 described herein may be a layer 1 or an analog millimeter wave repeater, which is associated with lower cost, less processing, and lower latency than a layer 2 or layer 3 repeater.

A millimeter wave repeater 160 (sometimes referred to herein as a repeater 160) may perform directional communication by using beamforming to communicate with a network node 110 via a first beam pair (e.g., a backhaul beam pair over a backhaul link with the network node 110) and to communicate with a UE 120 via a second beam pair (e.g., an access beam pair over an access link with the UE 120). For example, in example 400, repeater 160a can communicate with network node 110 via a first beam pair and can communicate with UE 120a via a second beam pair. Similarly, repeater 160b can communicate with network node 110 via a first beam pair and can communicate with UE 120a via a second beam pair. “Beam pair” may refer to a transmit (Tx) beam used by a first device for transmission and a receive (Rx) beam used by a second device for reception of information transmitted by the first device via the Tx beam.

As shown by reference number 405, a network node 110 may use a beam sweeping procedure to transmit communications via multiple beams over time (e.g., using time division multiplexing (TDM)). As shown by reference number 410, the repeater 160a may receive a communication via an Rx beam of the repeater 160a. As shown by reference number 415, the repeater 160a may relay each received communication via multiple Tx beams of the repeater 160a (e.g., using TDM). As used herein, “relaying” a communication may refer to transmitting the received communication (e.g., after amplifying the received communication) without decoding the received communication and/or without modifying information carried in the received communication. Alternatively, “relaying” a received communication may refer to transmitting the received communication after decoding the received communication and/or modifying information carried in the received communication. In some aspects, a received communication may be relayed using a different time resource, a different frequency resource, and/or a different spatial resource (e.g., a different beam) to transmit the communication as compared to a time resource, a frequency resource, and/or a spatial resource in which the communication was received. As shown by reference number 420, a UE 120a may receive a relayed communication. In some aspects, the UE 120a may generate a communication to be transmitted to the network node 110. The UE 120a may then transmit the communication to the repeater 160a for relaying to the network node 110.

As indicated above, FIG. 4 is provided as an example. Other examples may differ from what is described with regard to FIG. 4.

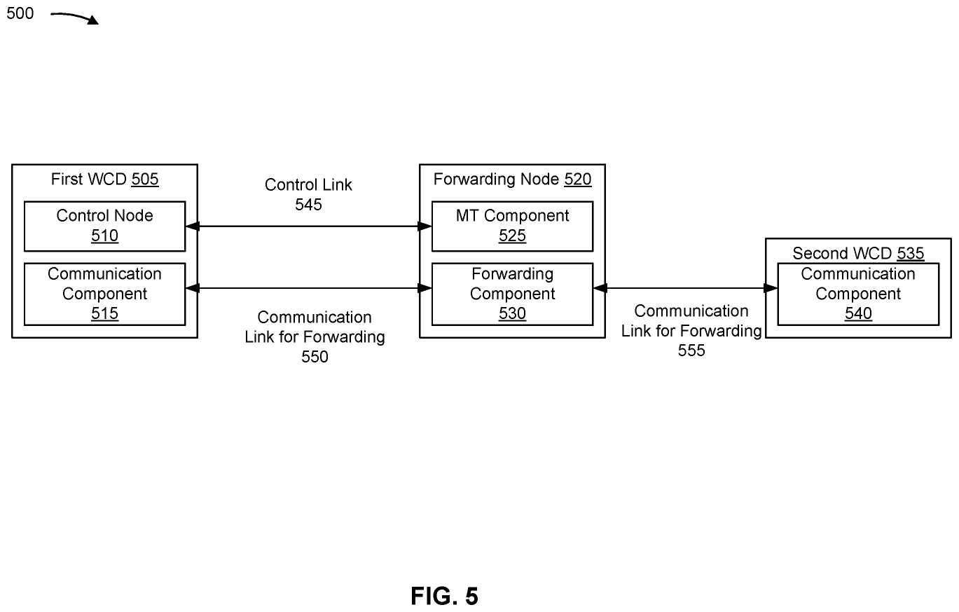

FIG. 5 is a diagram illustrating an example 500 of communicating using a forwarding node (e.g., a relay and/or a repeater, such as a millimeter wave repeater), in accordance with the present disclosure.

As shown in FIG. 5, a first WCD 505 (e.g., a network node 110 or a UE 120) may include a control node 510. The control node 510 may be configured to exchange control information with connected forwarding nodes. For example, the control node 510 may be configured to provide control information to connected forwarding nodes to indicate one or more parameters for forwarding communications. The first WCD 505 may include a communication component 515 that is configured to communicate with one or more additional WCDs (e.g., via one or more connected forwarding nodes).

As further shown in FIG. 5, a forwarding node 520 may be connected to the first WCD 505. The forwarding node 520 may include a mobile terminal (MT) component 525 (also referred to as a UE) that is configured to communicate with the control node 510 of the first WCD 505. Communications associated with the MT component 525 terminate or initiate at the forwarding node 520, such as control information from and/or feedback to the first WCD 505. The forwarding node 520 may include a forwarding component 530 that is configured to receive and forward communications to and/or from the first WCD 505 (e.g., the communication component 515). The forwarding component 530 may be configured to operate based at least in part on control information received at the MT component 525.

In some examples, the forwarding node 520 may include a network controlled repeater (NCR) that is configured to operate based at least in part on control information from the first WCD 505 (e.g., a network node and/or a control node of an associated network). In some examples, the MT component 525 may include an NCR-MT and the forwarding component 530 may include an NCR-Fwd (NCR forwarding component).

The forwarding node 520 may provide a wireless connection between the first WCD 505 and a second WCD 535. The second WCD 535 may include a communication component 540 for receiving from and/or transmitting to the forwarding node 520 (e.g., the forwarding component).

The control node 510 and the MT component 525 may establish a control link 545 through which the first WCD 505 may provide control information to the forwarding node 520. The control information may be used to control and/or configure operations of the forwarding component 530.

The communication component 515 may establish a communication link 550 for forwarding with the forwarding component 530. The communication component 540 may establish a communication link 555 for forwarding with the forwarding component 530. The communication links for forwarding may be based at least in part on the control information provided by the control node 510.

In some examples, the first WCD 505 may include a network node and the communication link 550 may be a backhaul link. The backhaul link may be a direct link or may include multiple hops to the network node. In some examples, the second WCD 535 may include a UE and the communication link 555 may be an access link.

As indicated above, FIG. 5 is provided as an example. Other examples may differ from what is described with regard to FIG. 5.

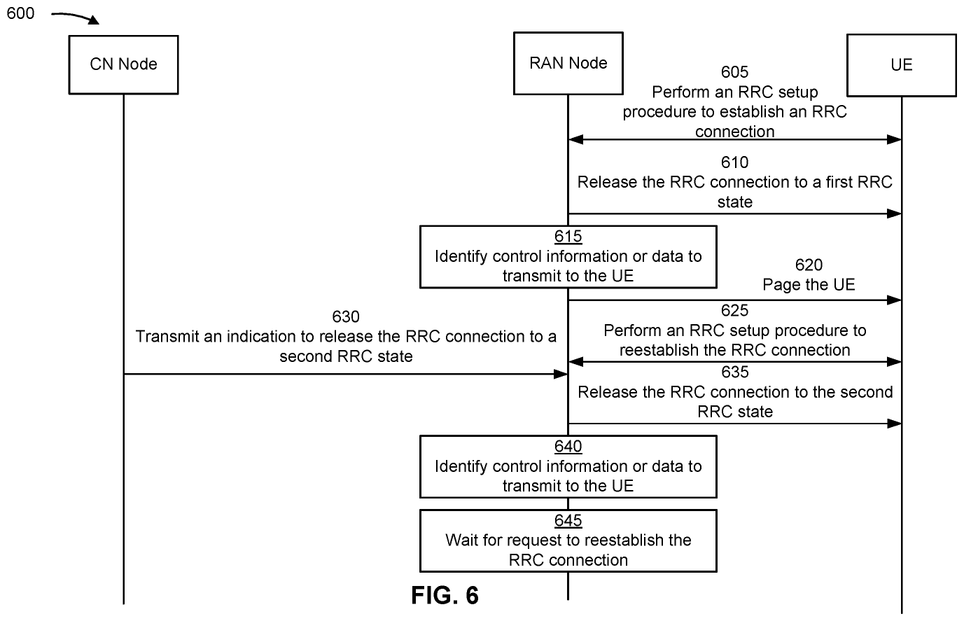

FIG. 6 is a diagram illustrating an example 600 of an RRC release and paging process, in accordance with the present disclosure. As shown in FIG. 6, a UE may communicate with a RAN node and the RAN node may be connected to a CN node (e.g., an access and mobility function (AMF)).

As shown by reference number 605, the UE and the RAN node may perform an RRC setup procedure to establish an RRC connection. For example, the RAN node and the UE may establish one or more radio bearers, a configuration of a search space for a control channel, periodic resources, and/or other configurations for communications.

Based at least in part on performing the RRC setup procedure, the UE may be in an RRC connected state. While in the RRC connected state, the UE may monitor a channel (e.g., a physical downlink control channel (PDCCH)) for scheduling information. Also while in the RRC connected state, the UE and the RAN node may communicate over the air.

As shown by reference number 610, the RAN node may release the RRC connection to a first RRC state. The RAN node may release the RRC connection based at least in part on inactivity of communications with the UE, failure to receive one or more responses from the UE, and/or a request from the UE or the CN node, among other examples. The first RRC state (e.g., an RRC-inactive state) may be a RAN-based RRC state where the RAN node has information needed to page the UE.

As shown by reference number 615, the RAN node may identify control information or data to transmit to the UE. Based at least in part on identifying control information or data to transmit to the UE, the RAN node may attempt to reestablish the RRC connection with the UE.

As shown by reference number 620, the RAN node may page the UE. The page may include a broadcast or multicast message that indicates one or more UEs to reestablish RRC connections with the RAN node. The message may include UE identifiers for each of the one or more UEs, with the UE identifiers known to the RAN node and respective UEs that are indicated by the UE identifiers.

As shown by reference number 625, the UE and the RAN node may perform an RRC setup procedure to reestablish the RRC connection. For example, the RAN node and the UE may establish one or more radio bearers, a configuration of a search space for a control channel, periodic resources, and/or other configurations for communications.

Based at least in part on establishing the RRC connection, the RAN node may transmit the control information and/or data to the UE. The UE and the RAN node may communicate until an RRC release occurs again.

As shown by reference number 630, the CN node may transmit, and the RAN node may receive, an indication to release the RRC connection to a second RRC state. The second RRC state may be a CN-based RRC state (e.g., RRC-idle state) where the CN node, and not the RAN node, has information needed to page the UE.

As shown by reference number 635, the RAN node may release the RRC connection to the second RRC state. Based at least in part on being in the second RRC state, the UE may not be reachable to the RAN node.

As shown by reference number 640, the RAN node may identify control information or data to transmit to the UE. The RAN node may identify data that originated from an application server that it intended for the UE or the RAN node may identify an update of control information associated with a different connection of the UE. For example, the UE may be an MT of a forwarding node that is performing forwarding and/or repeating operations at a forwarding component when the MT is in the second RRC state. The RAN node may attempt to update control information for the forwarding component when the MT is in the second RRC state, but the RAN node is unable to reach the UE.

As shown by reference number 645, the RAN node may wait for a request to reestablish the RRC connection. For example, the RAN node may wait for the UE to initiate a random access channel (RACH) procedure to reestablish the RRC connection. However, the UE may not initiate the RACH procedure within an efficient latency from the RAN node identifying control information or data to transmit to the UE. Additionally, or alternatively, the RAN node may wait until the CN node provides an indication to page the UE to trigger an RRC setup procedure to reestablish the RRC connection.

Based at least in part on the RAN node being unable to transmit the control information or data to the UE while the UE is in the second RRC state (e.g., an RRC-idle state), the control information may not be used to conserve power, network, communication, or computing resources, and/or an additional UE having a link to the RAN node via the UE may experience radio link failure and/or poor spectral efficiency. Additionally, or alternatively, the data may become stale and unusable, which may degrade performance and/or a user experience at the UE or the additional UE.

As indicated above, FIG. 6 is provided as an example. Other examples may differ from what is described with regard to FIG. 6.

In some aspects described herein, a repeater (e.g., an NCR MT) may receive a side control configuration from a RAN node. Within the side control configuration or another communication, the repeater may receive a validity time associated with the side control configuration. The validity time may be associated with an amount of time for which the side control configuration is to be used without receiving a new side control configuration or an update to the side control configuration. In some aspects, the validity time may be measured from reception of the side control configuration, reception of an indication of the validity time, or reception of an indication of an RRC release. Upon expiry of the validity time, the repeater may stop using the side control configuration for a forwarding operation. For example, the repeater may stop forwarding, begin a forwarding operation using a default or otherwise configured side control configuration, and/or initiate an RRC reconnection process, among other examples.

In this way, the RAN node may provide a side control configuration to the repeater when the repeater is otherwise unreachable by the RAN node by using a repeater-initiated indication of the side control configuration. The side control configuration may be used to conserve power, network, communication, or computing resources and/or a UE having a link to the RAN node via the repeater may avoid radio link failure and/or communicate with improved spectral efficiency. Additionally, or alternatively, the data may be provided to the repeater within a latency requirement and/or before expiry of the date, which may improve performance and/or a user experience at the UE.

In an example process, a RAN node may provide side control configuration to a repeater along with a validity time for the configuration. The repeater performs forwarding according to the side control configuration for the duration of the validity time. Upon expiry of the validity time, if the repeater has no connection to the RAN node, the repeater may establish (e.g., if in RRC-idle state) or resume (e.g., if in RRC-inactive state) an RRC connection with the RAN node. For a repeater in an RRC-idle state, or another similar RRC state, this provides a solution to the RAN node being unable to page the repeater. For example, the repeater triggers connection establishment to the RAN node based on timer expiry, rather than waiting to receive a page from the RAN node. Once the repeater has a connection to the RAN node, the repeater may receive updated side control configuration.

In some aspects, the repeater may include an amplify-and-forward repeater. The repeater may include a UE functionality (e.g., NCR-MT) to receive the side control configuration or the validity time. In some aspects, the validity time specifies the validity of the side control configuration following release of an RRC connection of the repeater.

In some aspects, the repeater receives the side control configuration and the validity time in the same message. For example, the repeater may receive the validity time and/or the side control configuration in an RRC release message.

In some aspects, upon expiry of the validity time, the repeater receives new side control configuration from the RAN node. For example, the repeater may receive the new side control configuration (e.g., an update to the side control configuration) based at least in part on reestablishing or resuming the RRC connection with the RAN node.

In some aspects, the repeater may establish or resume the RRC connection based at least in part on selecting the same RAN node and/or associated cell that is associated with the side control configuration prior to expiry of the validity timer.

In some aspects, upon or before expiry of the validity time, the repeater may receive an indication of an extension of the validity time. In some aspects, the repeater may receive the indication of the extension without completing an RRC reestablishment or RRC resume procedure.

In some aspects, upon expiry of the validity time, the repeater may perform a RACH procedure with the RAN node within which the repeater receives new side control configuration. In some aspects, the repeater receives dedicated RACH resources (e.g., one or more dedicated RACH occasions or a dedicated preamble) in the RRC release message. The repeater may then use the dedicated RACH resources to obtain the new side control configuration. In some aspects, the repeater may perform a RACH procedure with the RAN node within which the repeater receives an extension of the validity time. In some aspects, the repeater may receive the extension of the validity time within dedicated RACH resources indicate in the RRC release message.

In some aspects, upon expiry of the validity time, the repeater may discontinue forwarding operations until reconnecting to the RAN node to receive a new side control configuration. In some aspects, upon expiry of the validity time, the repeater switches to a new side control configuration based at least in part on which the repeater performs forwarding. In some aspects, the repeater receives (e.g., from the RAN node and/or with the indication of the validity time) an indication of the new side control configuration upon which the repeater is to perform forwarding upon expiry of the validity timer. In some aspects, the repeater may receive multiple validity times and associated side control configurations, where the repeater switches side control configurations based at least in part on in-sequence expiry of the validity times. In this way, the RAN node may schedule a series of side control configurations for the repeater to use without requiring the repeater to reestablish an RRC when switching between side control configurations.

In some aspects, the RAN node and the repeater may use validity times for side control configurations based at least in part on the repeater indicating a capability to use the validity times.

The procedure may be used where the repeater (e.g., an NCR-MT) is released to an RRC-idle state where the RAN node does not have information needed to page the repeater, where the repeater is released to an RRC-inactive state, and/or where the repeater stays in RRC-connected state.

In some aspects, a different procedure using a short message associated with a paging control channel may be used to page the repeater. For example, the RAN node may transmit a short message (e.g., a short message for paging or an extended short message) in a paging PDCCH. The message may indicate to stop a forwarding operation, to extend or restart a validity timer for side control configuration, to establish or resume an RRC connection, or that a new side control configuration is indicated.

In some aspects, the new side control configuration may be carried in an extension of the short message in the paging PDCCH, a flags and/or reserved bits in the short message, and/or a physical downlink shared channel (PDSCH) scheduled by short message and/or the PDCCH, among other examples. In some aspects, separate short message and/or paging PDCCHs and/or PDSCHs may be used for UEs and repeaters. For example, a RAN node may use different paging radio network temporary identifiers (RNTIs) for repeaters, different time and frequency resources for PDCCH monitoring, or flags and reserved bits in a legacy short message. In some aspects, the RAN node may indicate where the new side control configuration is to be carried and/or may indicate the new side control configuration using a paging early indication (PEI).

In some aspects, different repeaters may use different short messages and/or paging PDCCHs and/or PDSCHs. For example, different repeaters may receive the short message via a beam-specific transmission of a new PDCCH or PDSCH, via a new bitmap inside the message, and/or using different resources or RNTIs for different repeaters.

In some aspects, the RAN node may indicate new side control configuration to the repeater using a transmission received via a forwarding component of the repeater. For example, the repeater may monitor a level of power received on a configured resource when the MT of the repeater has been RRC released. In some aspects, the RAN node may transmit an energy signal and/or a beacon on the configured resource, which may indicate that the side control configuration is to be updated. The RAN node may use the configured resource to provide a small amount of information, such as an indication of an on/off state of the repeater, a start/stop timer for the validity time of the side control configuration, or simple indications.

FIG. 7 is a diagram of an example 700 associated with a validity time for a side control configuration, in accordance with the present disclosure. As shown in FIG. 7, a RAN node (e.g., network node 110, a CU, a DU, and/or an RU) may communicate with a repeater (e.g., an entity of a repeater node, such as an MT component 525 and/or an NCR-MT). In some aspects, the repeater may include an amplify-and-forward repeater or a UE entity of the repeater configured to communicate with the RAN node to receive the side control configuration or the validity time. For example, a UE (e.g., a UE entity) may perform one or more operations described herein as being performed by the repeater. In some aspects, the network node and the repeater may be part of a wireless network (e.g., wireless network 100). The RAN node may communicate with a UE via the repeater.

As shown by reference number 705, the repeater and the RAN node may perform an RRC setup procedure to establish an RRC connection. For example, the RAN node and the repeater may establish one or more radio bearers, a configuration of a search space for a control channel, periodic resources, and/or other configurations for communications. In some aspects, the repeater transmits an indication of support for validity times (e.g., as part of the RRC setup procedure). In some aspects, the repeater may receive configurations of validity times based at least in part on the indication of support for the validity times.

As shown by reference number 710, the repeater may receive, and the RAN node may transmit, side control configuration. The side control configuration may indicate one or more parameters for a forwarding operation.

As shown by reference number 715, the repeater may perform forwarding between the RAN node and the UE using (e.g., based at least in part on) the side control configuration.

As shown by reference number 720, the repeater may receive, and the RAN node may transmit, an update for side control configuration and a validity time associated with the side control configuration. The validity time may specify a time for which the side control configuration is valid following a release of the RRC connection between the repeater (e.g., an MT of the repeater) and the RAN network node. In some aspects, the repeater may further receive an indication of an operation for the repeater to perform upon expiry of the validity time. For example, repeater may be instructed to switch to a different side control configuration. In some aspects, the repeater may be instructed to use a validity time for the different side control configuration.

As shown by reference number 725, the RAN node may RRC release the repeater. For example, the RAN node may transmit an indication of the RRC release to the repeater. In some aspects, the indication of the RRC release may be included in a same message as the update for side control configuration and the validity time. For example, the repeater may receive the update for the side control configuration and the validity time in an RRC release message.

In some aspects, the RRC release message may indicate resources to be used to receive an indication associated with the validity time and/or the side control configuration. For example, the RRC release message may indicate dedicated RACH resources for receiving an extension of the validity time or an update to the side control configuration via the dedicated RACH resources.

As shown by reference number 730, the repeater may perform forwarding using the side control configuration until expiry of the validity time (e.g., for a duration of the validity time). For example, while an MT of the repeater is RRC released, a forwarding component of the repeater may continue to perform forwarding operations using the side control configuration received via the MT prior to the RRC release.

As shown by reference number 735, the repeater may receive a validity time extension. In some aspects, the repeater may receive the validity time extension via a RACH message or a short message (e.g., a short message of paging procedure). The validity time extension may indicate that the side control configuration is valid for additional time as indicated by the validity time extension.

As shown by reference number 740, the repeater may identify expiry of the validity time. In some aspects, the repeater may cease forwarding operations based at least in part on expiry of the validity time. In some aspects, the repeater may switch to a different side control configuration based at least in part on expiry of the validity time.

In some aspects, the different side control configuration may be used until reception of an update to the side control configuration. For example, the different side control configuration may be a default side control configuration (e.g., having reduced forwarding operations and/or transmission power). In some aspects, the repeater may receive an indication of the different side control configuration and/or an associated validity time prior to the RRC release from the connection with the RAN node.

In some aspects, the repeater may switch to an additional different side control configuration based at least in part on expiration of an additional validity time associated with the different side control configuration. In this way, the repeater may sequentially use a set of different side control configurations.

As shown by reference number 745, the repeater may perform an RRC setup or resume procedure to reestablish the RRC connection or to obtain an update to the side control configuration (e.g., new side control configuration) based at least in part on expiry of the validity time. In some aspects, the repeater may select the RAN node for resuming the RRC connection based at least in part on the RAN node being associated with the side control configuration prior to expiry of the validity time and/or prior to RRC release.

In some aspects, based at least in part on performing the RRC setup or resume procedure, the repeater may receive an update to the side control configuration. In this way, the repeater may receive the update to the side control configuration based at least in part on expiry of the validity time.

In some aspects, the RRC setup or resume procedure may include performing a RACH procedure with the RAN node based at least in part on expiry of the validity time. In some aspects, the network node may receive an update to the side control configuration via the RACH procedure (e.g., prior to reestablishing or resuming the RRC connection). In some aspects, the repeater may resume the RRC connection with the RAN node to receive the update to the side control configuration. In some aspects, the repeater may receive an indication of an extension of the validity time during the RRC setup or resume procedure, such as the RACH procedure.

In some aspects, the repeater may receive an extension of the validity time or an update to the side control configuration via RACH resources (e.g., dedicated RACH resources)

As shown by reference number 750, the repeater may perform forwarding using the side control configuration until expiry of the validity time. In some aspects, the side control configuration may be updated side control configuration and the validity time may be associated with a current side control configuration (e.g., the updated side control configuration). In some aspects, the repeater may resume forwarding operations after reconnecting to the RAN node or after otherwise receiving an indication of the side control configuration and/or a validity time extension.

Based at least in part on the RAN node being able to provide a side control configuration to the repeater when the repeater is otherwise unreachable by the RAN node by using a repeater-initiated indication of the side control configuration. The side control configuration may be used to conserve power, network, communication, or computing resources and/or a UE having a link to the RAN node via the repeater may avoid radio link failure and/or communicate with improved spectral efficiency. Additionally, or alternatively, the data may be provided to the repeater within a latency requirement and/or before expiry of the date, which may improve performance and/or a user experience at the UE.

As indicated above, FIG. 7 is provided as an example. Other examples may differ from what is described with respect to FIG. 7.

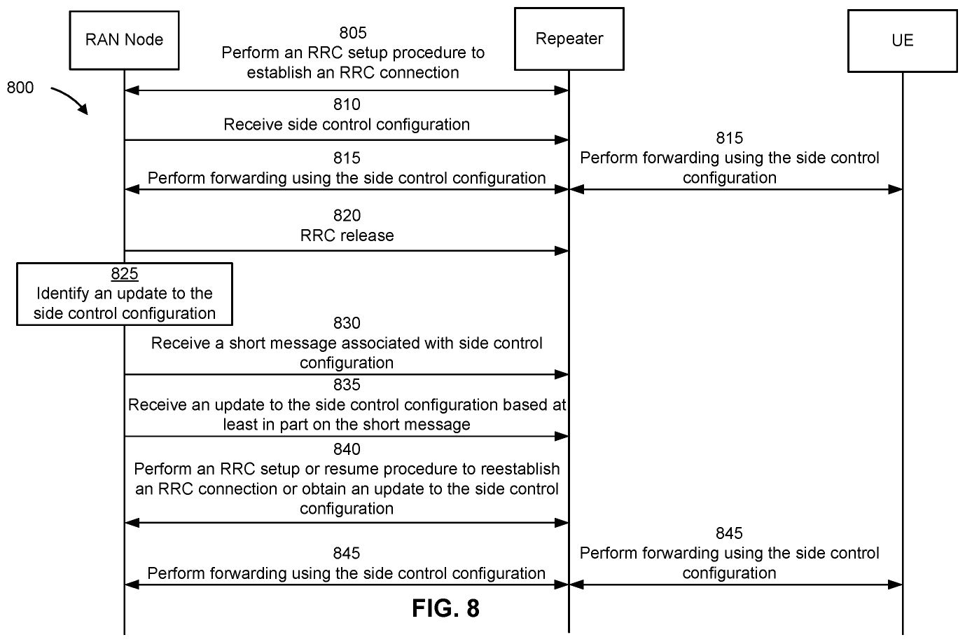

FIG. 8 is a diagram of an example 800 associated with a short message for a side control configuration, in accordance with the present disclosure. As shown in FIG. 8, a RAN node (e.g., network node 110, a CU, a DU, and/or an RU) may communicate with a repeater (e.g., an entity of a repeater node, such as an MT component 525 and/or an NCR-MT). In some aspects, the repeater may include an amplify-and-forward repeater or a UE entity of the repeater configured to communicate with the RAN node to receive the side control configuration or the validity time. In some aspects, the network node and the repeater may be part of a wireless network (e.g., wireless network 100). The RAN node may communicate with a UE via the repeater.

As shown by reference number 805, the repeater and the RAN node may perform an RRC setup procedure to establish an RRC connection. For example, the RAN node and the repeater may establish one or more radio bearers, a configuration of a search space for a control channel, periodic resources, and/or other configurations for communications. In some aspects, the repeater transmit an indication of support for validity times (e.g., as part of the RRC setup procedure). In some aspects, the repeater may receive configurations of validity times based at least in part on the indication of support for the validity times.

As shown by reference number 810, the repeater may receive, and the RAN node may transmit, side control configuration. The side control configuration may indicate one or more parameters for a forwarding operation.

As shown by reference number 815, the repeater may perform forwarding between the RAN node and the UE using (e.g., based at least in part on) the side control configuration.

As shown by reference number 820, the RAN node may RRC release the repeater. For example, the RAN node may transmit an indication of the RRC release to the repeater. In some aspects, the RRC release message may indicate resources to be used to receive an indication associated with the validity time and/or the side control configuration. For example, the RRC release message may indicate a downlink control channel (e.g., a shared downlink control channel) that may be used to indicate a short message and/or paging. The downlink control channel may be a paging PDCCH and/or a short message PDCCH.

As shown by reference number 825, the RAN node may identify an update to the side control configuration. For example, the RAN node may identify one or more parameters for forwarding to be updated. The parameters may include, for example, beam information for an access link with one or more UEs, a time domain duplexing uplink and downlink configuration, and/or on-off information (e.g., turn off to conserve power and computing resources and/or to avoid amplifying noise or interfering signals).

As shown by reference number 830, the repeater may receive, and the RAN node may transmit, a short message associated with the side control configuration. In some aspects, the repeater may receive the short message in a paging control channel or other common downlink channel. In some aspects, the repeater may receive the short message using resources configured during the RRC setup procedure and/or within the RRC release message, among other examples.

In some aspects, the short message may include an indication to cease forwarding operations, an indication to extend or restart a validity time associated with the side control configuration, an indication to establish or resume a connection with the RAN node, an indication of an update to the side control configuration, among other examples. In some aspects, the short message may indicate the information associated with the side control configuration in an extension of the short message in the control channel, a flag of the short message, and/or a reserved bit of the short message, among other examples.

In some aspects, the short message may indicate, within the information associated with the side control configuration, an allocation of a data channel that includes additional information associated with the side control configuration. In some aspects, the short message is configured to provide the information associated with the side control configuration based at least in part on the repeater being a repeater. For example, the short message may be configured to be used with repeaters (e.g., not endpoint UEs other than for the MT of the repeater).

In some aspects, the short message includes a paging early indication of a paging procedure.

As shown by reference number 835, the repeater may receive, and the RAN node may transmit, an update to the side control configuration based at least in part on the short message. For example, the repeater may receive the update within the short message, within an extension of the short message, and/or within a subsequent communication that is scheduled or requested using the short message.

As shown by reference number 840, the repeater may perform an RRC setup or resume procedure to reestablish the RRC connection or to obtain an update to the side control configuration (e.g., new side control configuration) based at least in part on receiving the short message. In some aspects, the repeater may select the RAN node for resuming the RRC connection based at least in part on the RAN node being associated with the side control configuration prior to RRC release.

As shown by reference number 845, the repeater may perform forwarding using the side control configuration. In some aspects, the side control configuration may be updated side control configuration received based at least in part on receiving the short message. In some aspects, the repeater may resume forwarding operations after reconnecting to the RAN node or after otherwise receiving an indication of the side control configuration.

Based at least in part on the RAN node being able to provide a side control configuration to the repeater when the repeater is otherwise unreachable by the RAN node by using an repeater-initiated indication of the side control configuration. The side control configuration may be used to conserve power, network, communication, or computing resources and/or a UE having a link to the RAN node via the repeater may avoid radio link failure and/or communicate with improved spectral efficiency. Additionally, or alternatively, the data may be provided to the repeater within a latency requirement and/or before expiry of the date, which may improve performance and/or a user experience at the UE.

As indicated above, FIG. 8 is provided as an example. Other examples may differ from what is described with respect to FIG. 8.

FIG. 9 is a diagram illustrating an example process 900 performed, for example, by a repeater, in accordance with the present disclosure. Example process 900 is an example where the repeater (e.g., forwarding node 520, an NCR-MT, and/or a network node 110) performs operations associated with validity time for a side control configuration.

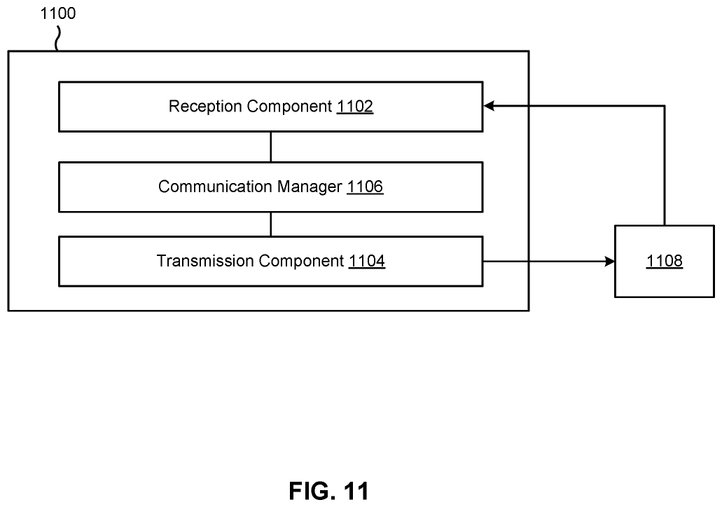

As shown in FIG. 9, in some aspects, process 900 may include receiving a side control configuration from a RAN node (block 910). For example, the repeater (e.g., using communication manager 150, reception component 1102 and/or communication manager 1106, depicted in FIG. 11) may receive a side control configuration from a RAN node, as described above.

As further shown in FIG. 9, in some aspects, process 900 may include receiving an indication of a validity time associated with the side control configuration (block 920). For example, the repeater (e.g., using communication manager 150, reception component 1102, and/or communication manager 1106, depicted in FIG. 11) may receive an indication of a validity time associated with the side control configuration, as described above.

As further shown in FIG. 9, in some aspects, process 900 may include forwarding signaling to or from the RAN node based on the side control configuration for a duration of the validity time (block 930). For example, the repeater (e.g., using communication manager 150, reception component 1102, transmission component 1104, and/or communication manager 1106, depicted in FIG. 11) may forward signaling to or from the RAN node based on the side control configuration for a duration of the validity time, as described above.

Process 900 may include additional aspects, such as any single aspect or any combination of aspects described below and/or in connection with one or more other processes described elsewhere herein.

In a first aspect, the repeater comprises one or more of an amplify-and-forward repeater, or a UE entity of the repeater configured to communicate with the RAN node to receive the side control configuration or the validity time.

In a second aspect, alone or in combination with the first aspect, process 900 includes receiving an indication to release an RRC connection with the RAN node, wherein the validity time specifies a time for which the side control configuration is valid following the release of the RRC connection.

In a third aspect, alone or in combination with one or more of the first and second aspects, receiving the side control configuration and receiving the validity time comprises receiving the side control configuration and the indication of the validity time in a single message from the RAN node.

In a fourth aspect, alone or in combination with one or more of the first through third aspects, receiving the side control configuration and receiving the validity time comprises receiving one or more of the validity time and/or the side control configuration in an RRC release message.

In a fifth aspect, alone or in combination with one or more of the first through fourth aspects, process 900 includes receiving an update to the side control configuration based at least in part on expiry of the validity time.

In a sixth aspect, alone or in combination with one or more of the first through fifth aspects, process 900 includes resuming a RRC connection with the RAN node to receive the update to the side control configuration.

In a seventh aspect, alone or in combination with one or more of the first through sixth aspects, process 900 includes selecting the RAN node for resuming the RRC connection based at least in part on the RAN node being associated with the side control configuration prior to expiry of the validity time.

In an eighth aspect, alone or in combination with one or more of the first through seventh aspects, process 900 includes receiving an indication of an extension of the validity time based at least in part on or before expiry of the validity time.

In a ninth aspect, alone or in combination with one or more of the first through eighth aspects, process 900 includes performing a RACH procedure with the RAN node based at least in part on expiry of the validity time, and receiving an update to the side control configuration via the RACH procedure.

In a tenth aspect, alone or in combination with one or more of the first through ninth aspects, performing the RACH procedure comprises transmitting a RACH message using dedicated RACH resources in an RRC release message.

In an eleventh aspect, alone or in combination with one or more of the first through tenth aspects, process 900 includes performing a RACH procedure with the RAN node based at least in part on expiry of the validity time, and receiving an extension of the validity time via the RACH procedure.

In a twelfth aspect, alone or in combination with one or more of the first through eleventh aspects, process 900 includes receiving an indication of dedicated RACH resources in an RRC release message, and receiving an extension of the validity time or an update to the side control configuration via the dedicated RACH resources.

In a thirteenth aspect, alone or in combination with one or more of the first through twelfth aspects, process 900 includes ceasing forwarding operations based at least in part on expiry of the validity time, and resuming forwarding operations after reconnecting to the RAN node.

In a fourteenth aspect, alone or in combination with one or more of the first through thirteenth aspects, process 900 includes switching to a different side control configuration based at least in part on expiry of the validity time.

In a fifteenth aspect, alone or in combination with one or more of the first through fourteenth aspects, process 900 includes receiving an indication of the different side control configuration from the RAN node based at least in part on receiving the indication of the validity time.

In a sixteenth aspect, alone or in combination with one or more of the first through fifteenth aspects, process 900 includes switching to an additional different side control configuration based at least in part on expiration of an additional validity time associated with the different side control configuration.

In a seventeenth aspect, alone or in combination with one or more of the first through sixteenth aspects, process 900 includes receiving an indication of the validity time, the additional validity time, the different side control configuration, and the additional different side control configuration before an RRC release from a connection with the RAN node.

In an eighteenth aspect, alone or in combination with one or more of the first through seventeenth aspects, process 900 includes transmitting an indication of support for validity times, wherein receiving the configuration of the validity time is based at least in part on the indication of support.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a repeater, in accordance with the present disclosure. Example process 1000 is an example where the repeater (e.g., forwarding node 520, an NCR-MT, and/or a network node 110) performs operations associated with validity time for a side control configuration.

As shown in FIG. 10, in some aspects, process 1000 may include receiving a side control configuration from a RAN node (block 1010). For example, the repeater (e.g., using communication manager 150, reception component 1102 and/or communication manager 1106, depicted in FIG. 11) may receive a side control configuration from a RAN node, as described above.

As further shown in FIG. 10, in some aspects, process 1000 may include releasing an RRC connection with the RAN node (block 1020). For example, the repeater (e.g., using communication manager 150 and/or communication manager 150, depicted in FIG. 11) may release an RRC connection with the RAN node, as described above.

As further shown in FIG. 10, in some aspects, process 1000 may include receiving a short message in a paging control channel, the short message providing information associated with the side control configuration (block 1030). For example, the repeater (e.g., using communication manager 150, reception component 1102 and/or communication manager 1106, depicted in FIG. 11) may receive a short message in a paging control channel, the short message providing information associated with the side control configuration, as described above.

Process 1000 may include additional aspects, such as any single aspect or any combination of aspects described below and/or in connection with one or more other processes described elsewhere herein.

In a first aspect, the short message comprises one or more of an indication to cease forwarding operations, an indication to extend or restart a validity time associated with the side control configuration, an indication to establish or resume a connection with the RAN node, or an indication of an update to the side control configuration.

In a second aspect, alone or in combination with the first aspect, the short message indicates the information associated with the side control configuration in one or more of an extension of the short message in the control channel, a flag of the short message, or a reserved bit of the short message.

In a third aspect, alone or in combination with one or more of the first and second aspects, the information associated with the side control configuration indicates an allocation of a data channel that includes additional information associated with the side control configuration.

In a fourth aspect, alone or in combination with one or more of the first through third aspects, the short message is configured to provide the information associated with the side control configuration based at least in part on the repeater being a repeater.

In a fifth aspect, alone or in combination with one or more of the first through fourth aspects, the short message comprises a paging early indication.

In a sixth aspect, alone or in combination with one or more of the first through fifth aspects, the short message is configured for reception by the repeater.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a repeater, or a repeater may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 150 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIGS. 7-8 Additionally, or alternatively, the apparatus 1100 may be configured to perform one or more processes described herein, such as process 900 of FIG. 9, process 1000 of FIG. 10, or a combination thereof. In some aspects, the apparatus 1100 and/or one or more components shown in FIG. 11 may include one or more components of the repeater described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the repeater described in connection with FIG. 2.

The transmission component 1104 may transmit communications, such as reference signals, control information, data communications, or a combination thereof, to the apparatus 1108. In some aspects, one or more other components of the apparatus 1100 may 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, a modem, a modulator, a transmit MIMO processor, a transmit processor, a controller/processor, a memory, or a combination thereof, of the repeater described in connection with FIG. 2. In some aspects, the transmission component 1104 may be co-located with the reception component 1102 in a transceiver.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The reception component 1102 may receive a side control configuration from a RAN node. The reception component 1102 may receive an indication of a validity time associated with the side control configuration. The communication manager 1106 may forward signaling to or from the RAN node based on the side control configuration for a duration of the validity time.

The reception component 1102 may receive an indication to release an RRC connection with the RAN node wherein the validity time specifies a time for which the side control configuration is valid following the release of the RRC connection.

The reception component 1102 may receive an update to the side control configuration based at least in part on expiry of the validity time.

The communication manager 1106 may resume a RRC connection with the RAN node to receive the update to the side control configuration.

The communication manager 1106 may select the RAN node for resuming the RRC connection based at least in part on the RAN node being associated with the side control configuration prior to expiry of the validity time.

The reception component 1102 may receive an indication of an extension of the validity time based at least in part on or before expiry of the validity time.

The communication manager 1106 may perform a RACH procedure with the RAN node based at least in part on expiry of the validity time.

The reception component 1102 may receive an update to the side control configuration via the RACH procedure.

The communication manager 1106 may perform a RACH procedure with the RAN node based at least in part on expiry of the validity time.

The reception component 1102 may receive an extension of the validity time via the RACH procedure.

The reception component 1102 may receive an indication of dedicated RACH resources in an RRC release message.

The reception component 1102 may receive an extension of the validity time or an update to the side control configuration via the dedicated RACH resources.

The communication manager 1106 may cease forwarding operations based at least in part on expiry of the validity time.

The communication manager 1106 may resume forwarding operations after reconnecting to the RAN node.

The communication manager 1106 may switch to a different side control configuration based at least in part on expiry of the validity time.

The reception component 1102 may receive an indication of the different side control configuration from the RAN node based at least in part on receiving the indication of the validity time.

The communication manager 1106 may switch to an additional different side control configuration based at least in part on expiration of an additional validity time associated with the different side control configuration.

The reception component 1102 may receive an indication of the validity time, the additional validity time, the different side control configuration, and the additional different side control configuration before an RRC release from a connection with the RAN node.

The transmission component 1104 may transmit an indication of support for validity times wherein receiving the configuration of the validity time is based at least in part on the indication of support.

The reception component 1102 may receive a side control configuration from a RAN node. The communication manager 1106 may release an RRC connection with the RAN node. The reception component 1102 may receive a short message in a paging control channel, the short message providing information associated with the side control configuration.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a repeater, comprising: receiving a side control configuration from a radio access network (RAN) node; receiving an indication of a validity time associated with the side control configuration; and forwarding signaling to or from the RAN node based on the side control configuration for a duration of the validity time.

Aspect 2: The method of Aspect 1, wherein the repeater comprises one or more of: an amplify-and-forward repeater, or a UE entity of the repeater configured to communicate with the RAN node to receive the side control configuration or the validity time.

Aspect 3: The method of any of Aspects 1-2, further comprising: receiving an indication to release an radio resource control (RRC) connection with the RAN node, wherein the validity time specifies a time for which the side control configuration is valid following the release of the RRC connection.

Aspect 4: The method of any of Aspects 1-3, wherein receiving the side control configuration and receiving the validity time comprises: receiving the side control configuration and the indication of the validity time in a single message from the RAN node.

Aspect 5: The method of any of Aspects 1-4, wherein receiving the side control configuration and receiving the validity time comprises: receiving one or more of the validity time and/or the side control configuration in an radio resource control (RRC) release message.

Aspect 6: The method of any of Aspects 1-5, further comprising: receiving an update to the side control configuration based at least in part on expiry of the validity time.

Aspect 7: The method of Aspect 6, further comprising: resuming a radio resource control (RRC) connection with the RAN node to receive the update to the side control configuration.

Aspect 8: The method of Aspect 7, further comprising selecting the RAN node for resuming the RRC connection based at least in part on the RAN node being associated with the side control configuration prior to expiry of the validity time.

Aspect 9: The method of any of Aspects 1-8, further comprising: receiving an indication of an extension of the validity time based at least in part on or before expiry of the validity time.

Aspect 10: The method of any of Aspects 1-9, further comprising: performing a random access channel (RACH) procedure with the RAN node based at least in part on expiry of the validity time, and receiving an update to the side control configuration via the RACH procedure.

Aspect 11: The method of Aspect 10, wherein performing the RACH procedure comprises transmitting a RACH message using dedicated RACH resources in a radio resource control (RRC) release message.

Aspect 12: The method of any of Aspects 1-11, further comprising: performing a random access channel (RACH) procedure with the RAN node based at least in part on expiry of the validity time, and receiving an extension of the validity time via the RACH procedure.

Aspect 13: The method of any of Aspects 1-12, further comprising: receiving an indication of dedicated RACH resources in an radio resource control (RRC) release message; and receiving an extension of the validity time or an update to the side control configuration via the dedicated RACH resources.

Aspect 14: The method of any of Aspects 1-13, further comprising: ceasing forwarding operations based at least in part on expiry of the validity time; and resuming forwarding operations after reconnecting to the RAN node.

Aspect 15: The method of any of Aspects 1-14, further comprising switching to a different side control configuration based at least in part on expiry of the validity time.

Aspect 16: The method of Aspect 15, further comprising: receiving an indication of the different side control configuration from the RAN node based at least in part on receiving the indication of the validity time.

Aspect 17: The method of Aspect 15, further comprising: switching to an additional different side control configuration based at least in part on expiration of an additional validity time associated with the different side control configuration.

Aspect 18: The method of Aspect 17, further comprising: receiving an indication of the validity time, the additional validity time, the different side control configuration, and the additional different side control configuration before an radio resource control (RRC) release from a connection with the RAN node.

Aspect 19: The method of any of Aspects 1-18, further comprising: transmitting an indication of support for validity times, wherein receiving the configuration of the validity time is based at least in part on the indication of support.

Aspect 20: A method of wireless communication performed by a repeater, comprising: receiving a side control configuration from a radio access network (RAN) node; releasing an radio resource control (RRC) connection with the RAN node; and receiving a short message in a paging control channel, the short message providing information associated with the side control configuration.

Aspect 21: The method of Aspect 20, wherein the short message comprises one or more of: an indication to cease forwarding operations, an indication to extend or restart a validity time associated with the side control configuration, an indication to establish or resume a connection with the RAN node, or an indication of an update to the side control configuration.

Aspect 22: The method of any of Aspects 20-21, wherein the short message indicates the information associated with the side control configuration in one or more of: an extension of the short message in the control channel, a flag of the short message, or a reserved bit of the short message.

Aspect 23: The method of any of Aspects 20-22, wherein the information associated with the side control configuration indicates an allocation of a data channel that includes additional information associated with the side control configuration.

Aspect 24: The method of any of Aspects 20-23, wherein the short message is configured to provide the information associated with the side control configuration based at least in part on the repeater being a repeater.

Aspect 25: The method of any of Aspects 20-24, wherein the short message comprises a paging early indication.

Aspect 26: The method of any of Aspects 20-25, wherein the short message is configured for reception by the repeater.

Aspect 27: An apparatus for wireless communication at a device, comprising a processor; memory coupled with the processor; and instructions stored in the memory and executable by the processor to cause the apparatus to perform the method of one or more of Aspects 1-26.

Aspect 28: A device for wireless communication, comprising a memory and one or more processors coupled to the memory, the one or more processors configured to perform the method of one or more of Aspects 1-26.

Aspect 29: An apparatus for wireless communication, comprising at least one means for performing the method of one or more of Aspects 1-26.

Aspect 30: A non-transitory computer-readable medium storing code for wireless communication, the code comprising instructions executable by a processor to perform the method of one or more of Aspects 1-26.

Aspect 31: A non-transitory computer-readable medium storing a set of instructions for wireless communication, the set of instructions comprising one or more instructions that, when executed by one or more processors of a device, cause the device to perform the method of one or more of Aspects 1-26.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
one or more memories; and
one or more processors, coupled to the one or more memories, configured to cause the UE to:
receive, from a radio access network (RAN) node, a configuration associated with a radio resource control (RRC) released state;
receive an indication of a validity time associated with the configuration;
operate, in the RRC released state, in accordance with the configuration for a duration of the validity time; and
perform an action associated with the configuration after an expiry of the validity time, the action including at least one of:
transmit a communication associated with resuming an RRC connection with the RAN node, or
refrain from performing one or more forwarding operations.

2. The UE of claim 1, wherein the one or more processors are further configured to cause the UE to:
receive an indication to release the RRC connection with the RAN node,
wherein the indication of the validity time specifies a time for which the configuration is valid following the release of the RRC connection.

3. The UE of claim 1, wherein the one or more processors, to receive the configuration and to receive the validity time, are configured to cause the UE to:
receive the configuration and the indication of the validity time in a single message from the RAN node.

4. The UE of claim 1, wherein the one or more processors, to receive the configuration and to receive the validity time, are configured to cause the UE to:
receive one or more of the validity time or the configuration in an RRC release message.

5. The UE of claim 1, wherein the one or more processors, to perform the action, are configured to cause the UE to:
receive an update to the configuration after the expiry of the validity time.

6. The UE of claim 5, wherein the one or more processors, to perform the action, are configured to cause the UE to:
resume the RRC connection with the RAN node to receive the update to the configuration.

7. The UE of claim 6, wherein the one or more processors are further configured to cause the UE to:
select the RAN node for resuming the RRC connection in association with the RAN node being associated with the configuration prior to expiry of the validity time.

8. The UE of claim 1, wherein the one or more processors are further configured to cause the UE to:
receive an indication of an extension of the validity time associated with or before expiry of the validity time.

9. The UE of claim 1, wherein the one or more processors, to perform the action, are configured to cause the UE to:
perform a random access channel (RACH) procedure with the RAN node after the expiry of the validity time, and
receive an update to the configuration via the RACH procedure.

10. The UE of claim 9, wherein the one or more processors, to perform the action, are configured to cause the UE to:
transmit a RACH message using dedicated RACH resources indicated in an RRC release message.

11. A repeater for wireless communication, comprising:
one or more memories; and
one or more processors, coupled to the one or more memories, configured to cause the repeater to:
receive a side control configuration from a radio access network (RAN) node;
receive an indication of a validity time associated with the side control configuration; and
forward signaling to or from the RAN node associated with the side control configuration for a duration of the validity time.

12. The repeater of claim 11, wherein the repeater comprises one or more of:
an amplify-and-forward repeater, or
a UE entity of the repeater configured to communicate with the RAN node to receive the side control configuration or the validity time.

13. The repeater of claim 11, wherein the one or more processors are further configured to cause the repeater to:
receive an indication to release a radio resource control (RRC) connection with the RAN node,
wherein the validity time specifies a time for which the side control configuration is valid following the release of the RRC connection.

14. The repeater of claim 11, wherein the one or more processors are further configured to cause the repeater to:
receive an update to the side control configuration after expiry of the validity time.

15. The repeater of claim 14, wherein the one or more processors are further configured to cause the repeater to:
resume a radio resource control (RRC) connection with the RAN node to receive the update to the side control configuration.

16. The repeater of claim 11, wherein the one or more processors are further configured to cause the repeater to:
perform a random access channel (RACH) procedure with the RAN node after expiry of the validity time; and
receive an update to the side control configuration via the RACH procedure.

17. The repeater of claim 11, wherein the one or more processors are further configured to cause the repeater to:
cease forwarding operations after expiry of the validity time; and
resume forwarding operations after reconnecting to the RAN node.

18. A method for wireless communication performed by a user equipment (UE), comprising:
receiving, from a radio access network (RAN) node, a configuration associated with a radio resource control (RRC) released state;
receiving an indication of a validity time associated with the configuration;
operating, in the RRC released state, in accordance with the configuration for a duration of the validity time; and
performing an action associated with the configuration after an expiry of the validity time, the action including at least one of:
transmitting a communication associated with resuming an RRC connection with the RAN node, or
refraining from performing one or more forwarding operations.

19. The method of claim 18, wherein performing the action comprises:
receiving an update to the configuration after the expiry of the validity time.

20. The method of claim 18, wherein performing the action comprises:
performing a random access channel (RACH) procedure with the RAN node after the expiry of the validity time, and
receiving an update to the configuration via the RACH procedure.
